(19) United States
(12) Patent Application Publication
(10) Pub. No.: US 2002/0193094 A1
(43) Pub. Date: Dec. 19, 2002

(54) Method and system for downloading software products directly to wireless phones

(76) Inventors: John P. Lawless, Leawood, KS (US); Nicholas William Loader, Reno, NV (US); Richard Parasol, Mill Valley, CA (US)

Correspondence Address: THOMAS B. LUEBBERING, HOVEY, WILLIAMS, TIMMONS & COLLINS, 2405 Grand, Suite 400, Kansas City, MO, 64108, US

(21) Appl. No.: 09/881,957

(22) Filed: Jun. 15, 2001

(51) Int. Cl. H04M 11/00

(52) U.S. Cl. 455/407; 455/419; 455/406

(57) ABSTRACT

A method and system for quickly and easily downloading software products directly to wireless phones (14) without the use of personal computers, special wires and connectors, and credit cards. The method is implemented with a special pay-per-call numbering plan that, when dialed, prompts wireless telephone companies to route calls to a software products content provider (12). The software products content provider (12) then coordinates the transfer of selected software products to the wireless phones (14) and receives payment for the software products from the wireless telephone companies.

### BACKGROUND OF THE INVENTION

1. Field of the Invention

The present invention relates to wireless phones. More particularly, the invention relates to a method and system for downloading software products such as video games, ring tones, logos and banners directly to wireless phones.

2. Description of the Prior Art

Wireless phone use has increased dramatically in recent years. Wireless phones were initially used almost exclusively for making and receiving voice phone calls, but recently have been manufactured with more processing power and memory so that people may use their wireless phones to play video games, browse the Internet, store and display phone numbers, and store and display various logos, banners and other graphics.

Most wireless phones are sold with a few pre-loaded software products, but with increased processing and memory capabilities, many users desire to obtain additional software products. For example, most wireless phones are preprogrammed with one or more basic video games, several possible ring tones, and several logos or banners that may be used to decorate the screens of the phones. Once users become tired of these pre-loaded software products, they often desire to obtain new video games, ring tones, banners, etc.

The conventional way to install new software products on a wireless phone is to buy the software products either from a store or the Internet, store or download the software products on a personal computer, and then transfer the software products to the phone with special cabling or connectors that connect the phone to one of the computer's output ports. These prior art steps have several distinct disadvantages. First, they are inherently slow and cumbersome because the software must first be purchased, then loaded or downloaded onto a computer, and then transferred to a wireless phone using special cabling. Many wireless phone users infrequently use software products on their phones and therefore will not take the time to perform these steps. Second, these steps require the use of a personal computer, an Internet connection, and cabling or connectors not typically provided with wireless phones. Once again, many wireless phone users will not take the time to assemble all the necessary equipment to perform these steps. Third, these steps require the use of a credit card or some other payment mechanism for purchasing the software products, causing security concerns, especially when the software products are purchased via the Internet.

Accordingly, there is a need for an improved method for downloading software products to wireless phones that does not suffer from the limitations of the prior art.

### SUMMARY OF THE INVENTION

The present invention solves the above-described problems and provides a distinct advance in the art of wireless phones. More particularly, the present invention provides a method and system for quickly and easily downloading software products directly to wireless phones without the use of personal computers, special wires and connectors, and credit cards.

One preferred embodiment of the present invention allows wireless telephone users to directly download to their phones software products such as video games, ring tones, banners, and logos by dialing phone numbers within a special pay-per-call numbering plan. Phone numbers within the pay-per-call numbering plan route wireless calls to a wireless telephone service provider and then to a software products content provider. The software products content provider prompts the caller to select one or more software products to be downloaded and to enter information necessary to download the software products. The software products content provider then transfers the selected software product to the wireless telephone service provider which then transfers the software products to the wireless phone via an SMS gateway. The wireless telephone service provider bills the subscriber a premium rate for the phone call and transfers at least a portion of the premium rate to the software products content provider as payment for the downloaded software product.

In another preferred embodiment of the present invention, a caller may use a conventional landline phone and call the software products content provider using a 1-900 or other pay-per-call number. The caller is then prompted to enter information identifying a wireless telephone to which one or more software products are to be downloaded. Selected software products are then transferred to the wireless phone as described above.

The special pay-per-call numbering plan, as well as a list of software products available for purchase, may be advertised to wireless phone users in a conventional manner. For example, the pay-per-call numbering plan and software products may be added to advertising inserts placed in subscribers' wireless phone bills. Wireless phone users may then call the numbers within the advertised pay-per-call numbering plan to obtain the listed software products.

The present invention allows wireless phone users to select and download software products directly to their phones without using personal computers, special wiring or connectors, and/or credit cards. Charges for the downloaded software products are automatically added to the subscribers' wireless telephone bills and collected by wireless telephone service providers with other conventional charges. The software products content provider then receives payment directly from the wireless telephone service provider so that subscribers are only billed once for services and products related to their wireless phones.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a schematic diagram depicting communications and computing equipment that may be used to implement certain aspects of the present invention.

FIG. 2 is a schematic diagram depicting a preferred embodiment of the software products content provider.

FIG. 3 is a flow diagram depicting certain steps performed in a preferred method of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

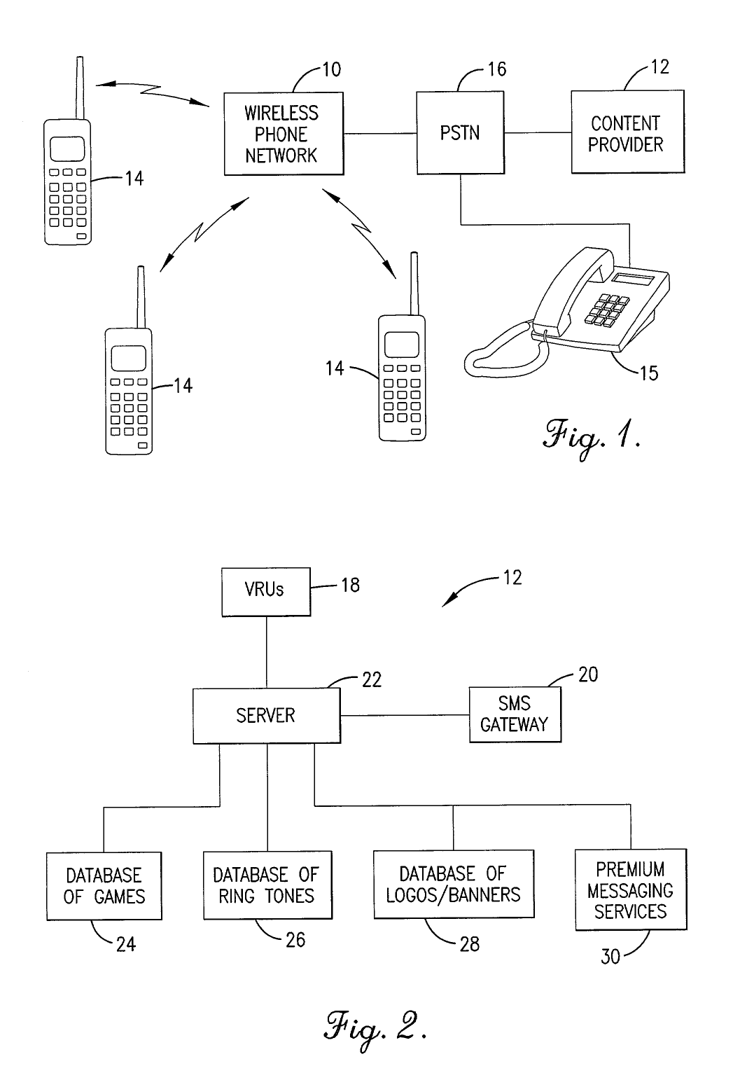

The present invention provides a method and system for downloading software products such as video games, ring tones, logos, banners, and premium messaging services directly to wireless phones. As illustrated in FIG. 1, one embodiment of the invention may be implemented with a wireless phone network 10 operated by a wireless telephone service provider and computing equipment 12 operated by a software products content provider.

The wireless phone network 10 is entirely conventional and may be operated by any wireless telephone service provider such as Sprint PCS, AT&T wireless, or Cingular. The wireless phone network 10 includes a plurality of conventional base stations, base station controllers, mobile switching centers, signal transfer points, service control points, home location registers and visitor location registers for providing wireless phone service to a plurality of conventional wireless telephones 14. The wireless telephone network 10 may be digital or analog and may operate using code division multiple access (CDMA), time division multiple access (TDMA), or frequency division multiple access (FDMA) techniques. The wireless telephones 14 may be provided by any conventional wireless telephone manufacturer such as Motorola, Nokia, or Qualcom and each includes sufficient processing and memory capabilities to store and execute the software products described herein.

The computing equipment 12 is operated by a software products content provider that wishes to implement the present invention. The software products content provider may be a single entity or multiple entities and may be associated with or completely independent from the wireless telephone service provider operating the wireless phone network 10. The computing equipment 12 is preferably connected with the wireless phone network 10 through the conventional public switched telephone network (PSTN) 16 or may be connected directly with a base station of the wireless phone network 10.

The computing equipment 12, which is illustrated in more detail in FIG. 2, preferably includes a plurality of voice response units 18, a server computer 22, and several databases or other memory for storing software products including, for example, a database 24 for storing video games, a database 26 for storing telephone ring tones, a database 28 for storing logos and banners that may be displayed on the wireless telephones 14, and a database 30 for storing premium messaging services.

The voice response units 18 are conventional and provide voice prompts and other information to wireless telephone callers who are transferred to the computing equipment 12 by the wireless phone network 10. Any number of voice response units 18 may be used, depending upon the call volume handled by the software products content provider.

The server computer 22 is programmed to implement many of the steps of the present invention described herein. The server computer 22 may be any conventional computing device such as a network computer running Windows NT, Novel Netware, Unix, or any other network operating system. The server computer 22 is coupled with and may access software products in the databases 24, 26, 28, 30 in a conventional manner.

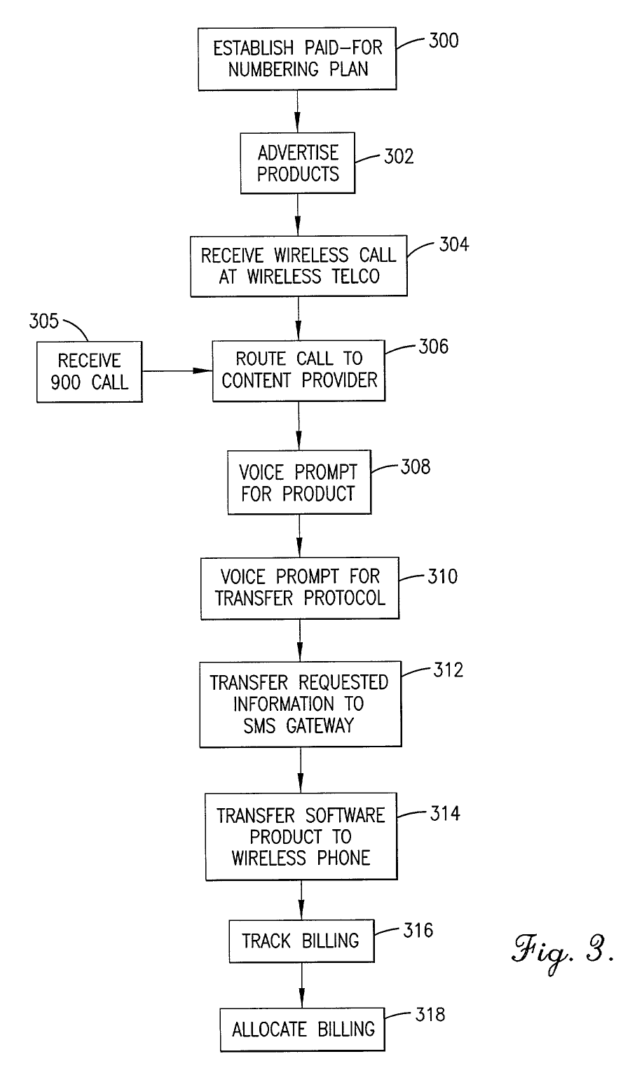

The flow chart of FIG. 3 shows the functionality and operation of a preferred implementation of the present invention in more detail. In this regard, some of the blocks of the flow chart may represent a module segment or portion of software code of the computer programs that operate the server computer 22. In some alternative implementations, the functions noted in the various blocks may occur out of the order depicted in FIG. 3. For example, two blocks shown in succession in FIG. 3 may in fact be executed substantially concurrently, or the blocks may sometimes be executed in the reverse order depending upon the functionality involved.

Implementation of one aspect of the present invention first requires that a special wireless pay-per-call numbering plan be established as depicted in box 300. The pay-per-call numbering plan may be any telephone numbering scheme that is adopted by at least one wireless telephone service provider operating at least one wireless phone network 10. Calls made by dialing phone numbers within the pay-per-call numbering plan are routed by the wireless telephone service provider to the computing equipment 12 and are charged a premium rate or fee as described in more detail below.

The special numbering plan preferably includes a plurality of related, but different phone numbers, each corresponding to software products in one of the databases 24, 26, 28. The pay-per-call numbering plan may, for example, include the telephone numbers 9000 through 9009. The 9000 number may be a general purpose number that connects calls to an information line of the computing equipment 12. The 9001 phone number may be associated with the database of video games 24, the 9002 number may be associated with the database of ring tones 26, and the 9003 number may be associated with the database of logos and banners 28. Additional numbers within the 9000 pay-per-call numbering plan may be used for other types of software products. If any of these phone numbers are dialed on one of the wireless phones 14, the wireless phone network 10 automatically routes the call to the computing equipment 12 for handling as described below.

The 9000 number pay-per-call numbering plan is but one example of a numbering plan that may be used to implement the present invention. Any pay-per-call numbering plan that instructs wireless telephone service providers to route calls to the computer equipment 12 and to charge a premium rate or fee for the calls may be used.

Once the pay-per-call numbering plan has been established, it may be advertised along with software products that are available for downloading as depicted in box 302. The advertising may take any form, for example, advertising inserts placed in the phone bills of wireless phone subscribers. The advertising inserts may list available software products next to the numbers within the pay-per-call numbering plan that may be dialed to obtain the software products. For example, the phone number 9001 may be advertised along with a list of video games that may be downloaded, the phone number 9002 may be advertised along with a list of ring tones that may be downloaded, and the phone number 9003 may be advertised along with a list of logos and banners that may be downloaded. Users of the wireless phones 14 who read these advertising inserts may then call the numbers within the advertised pay-per-call numbering plan and download the listed software products as described below.

When a wireless telephone user dials one of the numbers within the pay-per-call numbering plan, the call is received by the wireless phone network 10 in a conventional manner as depicted in box 304. The wireless phone network 10 recognizes the special pay-per-call numbering plan and routes the call to the computing equipment 12 via either the PSTN 16 or directly through one of the base stations of the wireless phone network 10 as depicted in box 306.

Callers may also contact the content provider's computer equipment 12 via a landline phone 15 and the PSTN 16 by dialing a 1-900 or other existing pay-per-call numbering plan as depicted in box 305. The caller may then enter information identifying a wireless phone 14 to which a software product is to be transferred.

Once the computing equipment 12 receives a call, one of the voice response units 18 provides operating instructions and/or voice prompts to the caller to assist in the selection of one or more software products as depicted in box 308. For example, if the caller dialed the 9001 number, which corresponds to software products within the database of video games 24, the caller may be prompted to identify which video game the caller wishes to download. This may be accomplished by providing the caller an audible list of all video games available for downloading or by prompting the caller to enter a code or string of digits corresponding to a particular video game as advertised in the billing insert described above.

The voice response units 18 may also prompt the caller for information needed to download the selected software product to the caller's wireless phone 14 as depicted in box 310. Download protocols or methods may vary depending on the type of wireless phone used and/or the wireless service provider; therefore, the voice response unit may prompt the caller for such information. In one embodiment, the caller is prompted to enter his or her wireless phone number so a selected software product may be downloaded to the phone via a SMS gateway 20.

The voice response units 18 transfer all information entered by a caller to the server computer 22. The server computer 22 analyzes the information entered by the caller, including the information entered to select a software product and the information entered regarding the download method, and then accesses the appropriate database 24, 26, 28, 30 to retrieve a copy of the selected software product.

The server computer 22 then transfers a copy of the selected software product to the SMS gateway 20 as depicted in box 312. The SMS gateway then transfers the software product to the appropriate wireless phone 14 as depicted in box 314. Such transfer may be accomplished via a secured message peer-to-peer connection, for example.

The wireless telephone service provider tracks or monitors all calls made using the pay-per-call numbering plan for billing purposes as depicted in box 316. The wireless telephone service provider preferably bills all calls made pursuant to the pay-per-call numbering plan at a premium rate per minute or a premium flat fee per call. For example, such calls may be billed at $1.50 per minute or a flat fee of $5.00 per call. The premium rate or premium flat fee is preferably fixed but may also vary according to which of the phone numbers within the pay-per-call numbering plan is dialed. For example, video games may be more expensive than ring tones so calls made to the 9001 number may cost more than calls made to the 9002 number. Charges for such calls are added to the wireless telephone bills sent to the users of the phones 14.

Charges for calls made using the pay-per-call numbering plan are allocated between the wireless telephone service provider and the software products content provider as depicted in box 318. For example, the wireless telephone service provider may retain a portion of the charges for routing and billing costs and expenses and then transfer the remaining portion of the charges to the software products content provider as compensation for the downloaded software products.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A method of downloading software products directly to wireless phones, the method comprising the steps of:
establishing a pay-per-call numbering plan that is adopted by at least one wireless telephone service provider;
receiving a call routed by the wireless telephone service provider from a user operating a wireless phone who dialed a phone number encompassed by the pay-per-call numbering plan;
prompting the user to use the wireless phone to select a software product to be downloaded;
selecting a transfer method based on a characteristic of the wireless phone;
transferring the software product to the wireless phone via the wireless telephone service provider using the transfer method; and
receiving payment for the software product from the wireless telephone service provider.

2. The method as set forth in claim 1, wherein the pay-per-call numbering plan includes a plurality of related, but different phone numbers each corresponding to one of a plurality of different types of software products.

3. The method as set forth in claim 2, the types of software products being selected from the group consisting of video games, telephone ring tones, logos, banners, and premium messaging services.

4. The method as set forth in claim 2, the phone numbers each including three or more digits, wherein the first three digits of the phone numbers are the same and additional digits vary according to the types of software products.

5. The method as set forth in claim 1, wherein the wireless telephone service provider bills the wireless telephone subscriber a premium rate for each minute of the call.

6. The method as set forth in claim 5, wherein the premium rate is the same for each of the phone numbers.

7. The method as set forth in claim 5, wherein the premium rate varies according to which of the phone numbers is dialed.

8. The method as set forth in claim 1, wherein the wireless telephone service provider bills the wireless telephone subscriber a premium flat fee for the call.

9. The method as set forth in claim 8, wherein the premium flat fee is the same for all of the phone numbers.

10. The method as set forth in claim 8, wherein the premium flat fee varies according to which of the phone numbers is dialed.

11. The method as set forth in claim 5, wherein the payment for the software product is a portion of the premium rate.

12. The method as set forth in claim 8, wherein the payment for the software product is a portion of the premium flat fee.

13. The method as set forth in claim 1, the characteristic of the wireless phone including a manufacturer of the phone.

14. The method as set forth in claim 1, the characteristic of the wireless phone including a type of wireless service provided by the wireless telephone service provider.

15. A method of downloading software products directly to wireless phones, the method comprising the steps of:
receiving a call routed by a wireless telephone service provider from a user operating a wireless phone who dialed a phone number encompassed by a pay-per-call numbering plan;
selecting a transfer method based on a characteristic of the wireless phone;
transferring a software product to the wireless phone via the wireless telephone service provider using the transfer method; and
receiving payment for the software product from the wireless telephone service provider.

16. The method as set forth in claim 15, further including the step of prompting the user to use the wireless phone to select the software product to be downloaded.

17. The method as set forth in claim 15, wherein the pay-per-call numbering plan includes a plurality of related, but different phone numbers each corresponding to one of a plurality of different types of software products.

18. The method as set forth in claim 17, the types of software products being selected from the group consisting of video games, telephone ring tones, logos, and banners.

19. The method as set forth in claim 17, the phone numbers each including three or more digits, wherein the first three digits of the phone numbers are the same and additional digits vary according to the types of software products.

20. The method as set forth in claim 15, the characteristic of the wireless phone including a manufacturer of the phone.

21. The method as set forth in claim 15, the characteristic of the wireless phone including a type of wireless service provided by the wireless telephone service provider.
